(19) United States
(12) Patent Application Publication
(10) Pub. No.: US 2008/0092501 A1
(43) Pub. Date: Apr. 24, 2008

(54) POLYGONAL FILTER ELEMENT WITH RADIUSED CORNERS, ASSEMBLIES, AND METHODS FOR FILTERING

(76) Inventors: Timothy D. Sporre, Brookyn Park, MN (US); Steven A. Johnson, St. Paul, MN (US); Bruce A. Johnson, Lake Elmo, MN (US); Michael W. Handley, Farmington, MN (US)

Correspondence Address: MERCHANT & GOULD PC, P.O. BOX 2903, MINNEAPOLIS, MN, 55402-0903, US

(21) Appl. No.: 11/673,894

(22) Filed: Feb. 12, 2007

Related U.S. Application Data
(60) Provisional application No. 60/743,302, filed on Feb. 16, 2006.

(51) Int. Cl. B01D 46/52

(52) U.S. Cl. 55/493; 55/497; 55/498

(57) ABSTRACT

A filter element for removing contaminant from a dirty stream, such as an air filter element for removing and/or coalescing liquid contaminant from an incoming dirty air stream. The filter element has a polygonal shape, with radiused corners. Such a shape mitigates pleat bunching, reduces airflow resistance, thus increasing in the volume of incoming air when compared to conventional cylindrical filter elements having the same surface area and pleat heights. Examples of polygonal shapes include rectangular (including square) and triangular. The filter element may be tapered.

This application claims priority to provisional application 60/743,302, filed Feb. 16, 2006 and entitled “Polygonal Filter Element with Radiused Corners, Assemblies, and Methods for Filtering Air”, the entire disclosure of which is incorporated herein by reference.

### FIELD OF THE DISCLOSURE

The present disclosure is related to air filtering systems having non-cylindrical, pleated filter elements, and methods of using systems equipped with these filter elements. In particular, the disclosure is directed to polygonal pleated filter elements with radiused corners.

### BACKGROUND OF THE DISCLOSURE

Many industries often encounter particulate matter suspended in the atmosphere. In some industries, this particulate matter is a valuable product, for example, starch; it would be beneficial if these suspended particulate could be recovered and reintroduced into the process. For other industries, such as metal or wood working, the particulate matter may be simply dust; it is desirable to remove dust particles from the air in order to provide a clear working environment. Other industries encounter liquid matter suspended in the atmosphere. It is generally desirable to remove or separate out the liquid from the air.

Systems for cleaning an air or other gas stream laden with particulate or liquid matter include air filter assemblies that have filter elements present in a housing. The gas stream, contaminated with particulate or liquid, typically is passed through the housing so that the contaminants impact on the filter element. Solid particulate matter is typically captured and retained by the filter element, whereas liquid matter typically coalesces and drains off of the filter element. Various shapes of filter elements are known.

Cylindrical filter elements are often used in air filter assemblies to process dust, other particles, and liquid from an air stream. Non-cylindrical filter elements, e.g., oval or elliptical, are sometimes used to provide increased filtration area within a housing as compared to cylindrical filter elements.

In a standard design of air filter assembly, an air filter assembly has a clean air chamber or plenum and a dirty air chamber or plenum. Particulate-laden or liquid-laden air is introduced into the dirty air chamber, and the particulates collect or liquid coalesces onto the filter. The filtered air passes through the filter media to the interior of the filter, and out into the clean air chamber.

The present disclosure provides a filter element that provides improved filtration capabilities.

### SUMMARY OF THE DISCLOSURE

The polygonal filter elements of the present disclosure provide performance gains over round and conventional oval filter elements. A polygonal filter element with radiused corners mitigates pleat bunching, and reduces restriction losses when used for collection of particulate (solid) matter or liquid matter from a gas stream (e.g., an air stream). As a result, higher air flows are achieved during contaminate (e.g., particulate and/or liquid) removal, together with extended filter element life.

The construction and arrangement of the polygonal filter elements, when used for contaminant removal, provide filtration improvements over previously known filter elements. The polygonal filter elements of rectangular shape, as described in the present disclosure, have less filter restriction than conventional cylindrical filter elements and provide greater air flow therethrough. In most embodiments, the restriction is at least about 9% less than for a rectangular element, preferably at least about 20% less at nominal airflow operating conditions, and more preferably at least about 25%. In most embodiments, the air flow is at least about 9% more for a polygonal filter element, preferably at least about 15%, and more preferably at least about 19% when compared to a cylindrical filter element with equivalent media area and pleat height.

The polygonal filter elements are typically rectangular (including square), parallelograms, or rhombuses; rectangular are the most common. Other polygonal shaped filter elements, such as triangular, pentagonal, hexagonal, and the like, are also within the scope of this disclosure. The filter elements may be tapered, such as having a pyramidal shape. Pyramidal elements could have, for example, three sides, four sides, five sides, etc., excluding the base, and could be truncated pyramids (i.e., not forming a point at the small end).

In one particular aspect, the present disclosure is directed to a filter element for collecting (e.g., removing, retaining, coalescing) contaminants, such as particulate and/or liquid matter. The filter element includes an extension of filter media having first and second opposite ends, with the filter media being pleated, and defining an filter interior. The filter media has a polygonal cross-sectional shape that has at least three side walls and three radiused corners; the cross-sectional shape may change (e.g., decrease) along the extension of the filter media. The filter may have a first end cap and a second end cap, so that the filter media extends between the first and second end caps, with the first end cap being an open end cap providing access to the filter interior. Although not required, the second end cap could be a closed end cap blocking access to the filter interior.

The filter can have a polygonal cross-sectional shape which has at least four side walls and four radiused corners. The four side walls can be a first side wall, a second side wall adjacent the first side wall, a third side wall opposite to and parallel to the first side wall and adjacent the second side wall, and a fourth side wall opposite the second side wall and adjacent the first and third side walls. For some shapes, the length of the third side wall is the same as the length of the first side wall; these could be rectangles, parallelograms, or rhombuses. Additionally, for some shapes the length of the fourth side wall is the same as the length of the second side wall; these could be rectangles or parallelograms. A ratio of the length of the first and third side walls to the length of the second and fourth side walls could be 1:1 (i.e., a square) to 2:1.

The filter element generally has a length of about 8 to about 40 inches, such as, e.g., 8 inches (about 20 cm), 10 inches (about 25 cm), 12 inches (about 30 cm), 15 inches (about 38 cm), 20 inches (about 50 cm), 25 inches (about 63.5 cm), 28 inches (about 71 cm), 30 inches (about 76 cm), 34 inches (about 86 cm), 36 inches (about 92 cm), or 40 inches (101 cm).

The filter could have an inner liner extending between the first and second end caps, with the filter media circumscribing the inner liner, and/or an outer liner extending between the first and second end caps, with the outer liner circumscribing the filter media.

The filter media could include cellulose, polymeric fibers, glass fibers, or other fibers. Any or all of these could be fine fibers, which includes microfibers and nanofibers. As provided above, the filter media is pleated, and could include pleat separators present between the pleated filter media. The pleat separators could be aluminum, such as corrugated aluminum.

The polygonal filter element can be placed in a housing to form a filter assembly. One particular use for filter elements of the disclosure is for liquid collection from a gas stream (e.g., air stream). In many embodiments, the liquid-laden gas stream is passed through the filter element in an out-to-in direction. Another particular use for filter elements of the disclosure is for particulate or other solid contaminant collection from a gas stream (e.g., air stream). In many embodiments, the contaminated gas stream is passed through the filter element in an out-to-in direction.

### BRIEF DESCRIPTION OF THE DRAWINGS

FIG. 1 is a perspective view of a rectangular pleated filter element according to the present disclosure;

FIG. 2 is a schematic top view of a polygonal pleated filter element, specifically a rectangular pleated filter element, according to the present disclosure, illustrated without the top end cap;

FIG. 3 is a schematic top view of another polygonal pleated filter element, specifically a rectangular (square) pleated filter element, according to the present disclosure, illustrated without the top end cap;

FIG. 4 is a schematic top view of yet another polygonal pleated filter element, specifically a rectangular pleated filter element, according to the present disclosure, illustrated without the top end cap, having dimensions indicated thereon;

FIG. 5 is a schematic top view of a convention cylindrical pleated filter element, illustrated within the top end cap, having dimensions indicated thereon;

FIG. 6 is a perspective view of a tapered rectangular pleated filter element according to the present disclosure;

FIG. 7 is a graphical representation of test data showing the effect of filter element configuration on filter restriction; and

FIG. 8 is a graphical representation of test data showing the effect of filter element configuration on airflow through the filter element

### DETAILED DESCRIPTION

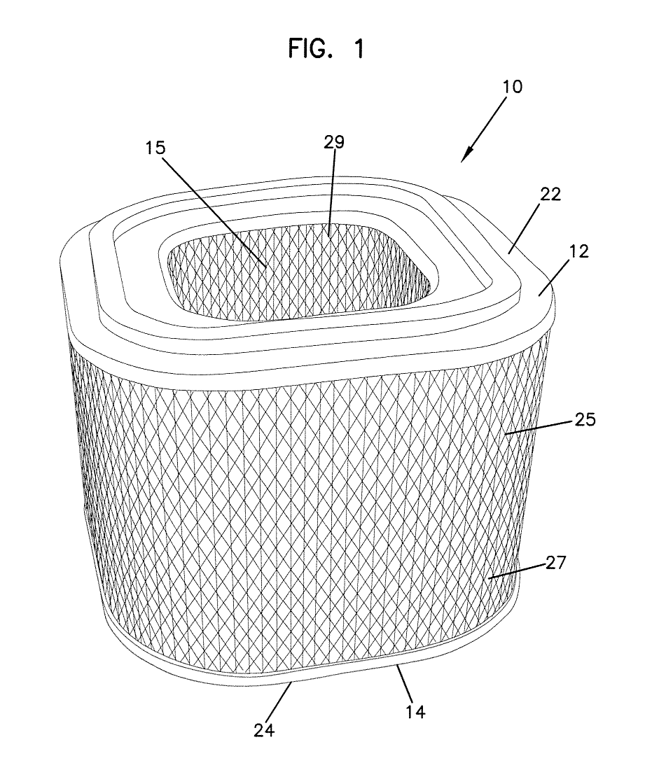

Referring to the figures, various embodiments of filter elements according to the present disclosure are provided. In FIG. 1, an element 10 is illustrated generally at 10.

Filter element 10 has a first end 12 and an opposite second end 14. An interior volume 15, further described below, is present between ends 12, 14. A first end cap 22 is located at first end 12 and a second end cap 24 is located at second end 14. In this embodiment, first end cap 22 is an “open” end cap, being an annular end cap and allowing access to interior 15 of filter element 10. Second end cap 24, in this embodiment, is a “closed” end cap, being a continuous cap that seals access to interior volume 15 of element 10. Each of end caps 22, 24 are polygonal end caps with radiused corners; in this specific embodiment, end caps 22, 24 are four-sided rectangular end caps with radiused corners.

Filter element 10 includes an extension of pleated media 25 extending from and preferably potted into first end cap 22 to second end cap 24. The shape of end caps 22, 24 is preferably the same as pleated media 25, i.e., polygonal with radiused corners. An optional outer liner 27 protects media 25 from any physical damage and provides compressive resistance and support to element 10. An optional inner liner 29 is positioned inside media 25 to additionally protect and/or support media 25. The constructions of end caps 22, 24 and liners 27, 29 are conventional and are well known.

Media 25, together with end caps 22, 24, define interior volume 15. For assemblies where filter element 10 is configured for “in-to-out” flow, interior volume 15 is a filtered or clean air chamber. For “in-to-out” flow, dirty air passes through media 25 from the exterior of media 25 (e.g., at outer liner 27) to interior volume 15. For assemblies where filter element 10 is configured for “out-to-in” flow, interior volume 15 is a dirty air chamber. For filter assemblies constructed to remove liquid from air, often referred to as liquid separators, filter element 10 is typically configured for “in-to-out” flow, so that liquid coalesces on and drains from the exterior of media 25. Filter elements 10 are particular suited for applications requiring liquid coalescing.

Filter element 10 of the present disclosure is a polygonal element having radiused corners. Examples of specific polygonal shapes include four-sided shapes such as rectangular (including square), parallelogram, or rhombus, three-sided (i.e., triangular), five-sided (e.g., pentagonal), six-sided (e.g., hexagonal), etc. The shape of filter element 10 is defined by at least three side walls and at least three corners; in most embodiments, filter element 10 is defined by four side walls and four corners. A rectangular element has two pairs of parallel side walls, with radiused corners of 90 degrees; if the four side walls are equal in length, the rectangle is a square. A parallelogram has two pairs of parallel side walls, with corners other than 90 degrees. A rhombus or rhomboid element has one pair of parallel side walls of different length, and a pair of oblique side walls that are the same length.

Filter element 10 often has a length of at least about 4 inches (about 10 cm) and usually no more than about 60 inches (about 152 cm). Filter element 10 generally has a length of about 8 inches (about 20 cm) to about 40 inches (about 101 cm). Examples of particular filter lengths include 8 inches (about 20 cm), 10 inches (about 25 cm), 12 inches (about 30 cm), 15 inches (about 38 cm), 20 inches (about 50 cm), 25 inches (about 63.5 cm), 28 inches (about 71 cm), 30 inches (about 76 cm), 34 inches (about 86 cm), 36 inches (about 92 cm), and 40 inches (101 cm).

Filter element 10 often has a maximum width, measured perpendicular to its length, of at least about 4 inches (about 10 cm) and usually no more than about 40 inches (about 101 cm). Filter element 10 generally has a maximum width of about 5 inches (about 12.7 cm) to about 25 inches (about 63.5 cm).

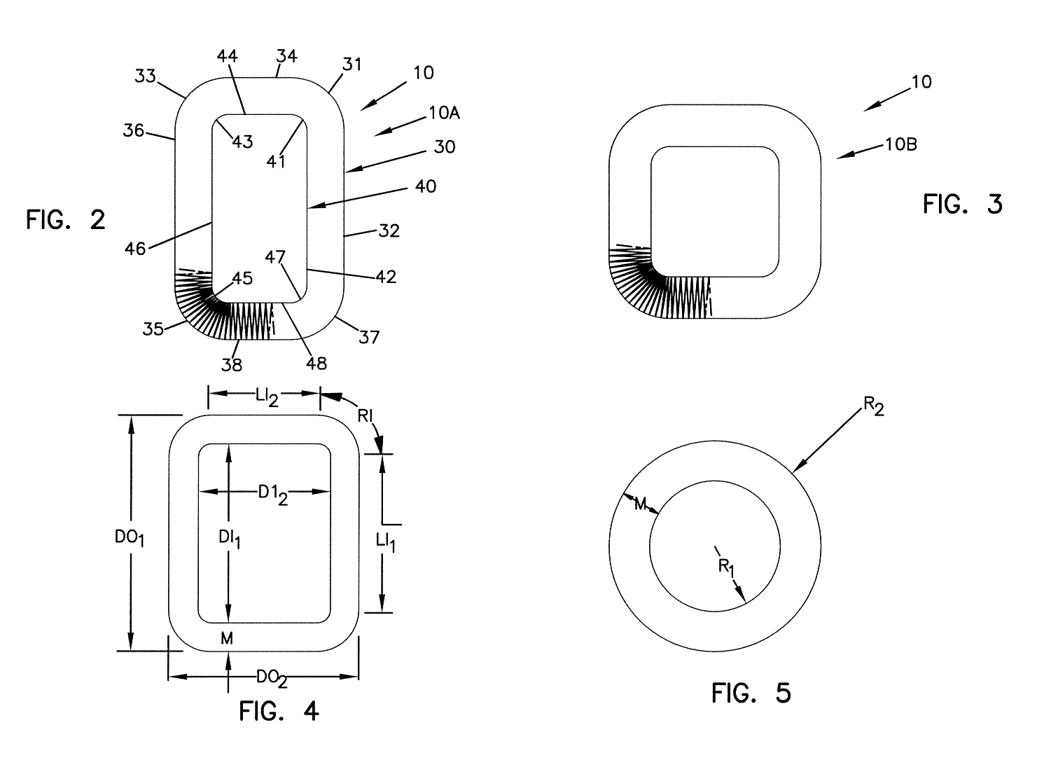

In FIG. 2, looking at the extension of media, a particular rectangular filter element 10 is shown in top view as element 10A. Filter element 10 is defined by an outer perimeter 30. The interior volume 15 (see FIG. 1) is generally defined by an inner perimeter 40.

Outer perimeter 30 is a rectangular shape with radiused corners. In particular, outer perimeter 30 has a first side wall 32, a second side wall 34, a third wall 36 and a fourth wall 38. First and third side walls 32, 36 are parallel to one another, second and fourth side walls 34, 38 are parallel to one another and orthogonal to both side wall 32 and side wall 36. Each of side walls 32, 34, 36, 38 is straight, flat, planar, or the like; side walls 32, 34, 36, 38 do not have a radius associated therewith.

Present between side walls 32, 34, 36, 38 are corners 31, 33, 35, 37. Specifically, corner 31 is present between side walls 32 and 34, corner 33 is present between side walls 34 and 36, corner 35 is present between side walls 36 and 38, and corner 37 is present between side walls 38 and 32. Each of corners 31, 33, 35, 37 has a radius associated therewith, with each of the radiuses preferably being the same.

Inner perimeter 40 is also a rectangular shape with radiused corners. In particular, inner perimeter 40 has a first inner side wall 42, a second inner side wall 44 a third inner side wall 46 and a fourth inner side wall 48. First and third side walls 42, 46 are parallel to one another, second and fourth side walls 44, 48 are parallel to one another and orthogonal to both side wall 42 and side wall 46. Each of inner side walls 42, 44, 46, 48 is straight, flat, planar, or the like; side walls 42, 44, 46, 48 do not have a radius associated therewith. Additionally, each of inner side walls 42, 44, 46, 48 is preferably parallel to its respective outer perimeter side wall, 32, 34, 36, 38.

Present between inner side walls 42, 44, 46, 48 are inner corners 41, 43, 45, 47. Specifically, corner 41 is present between side walls 42 and 44, corner 43 is present between side walls 44 and 46, corner 45 is present between side walls 46 and 48, and corner 47 is present between side walls 48 and 42. Each of corners 41, 43, 45, 47 has a radius associated therewith, with each of the radiuses preferably being the same.

The distance between parallel walls 32 and 42, 34 and 44, 36 and 46, and 38 and 48 is preferably the same. Additionally, the distance between corners 31 and 41, 33 and 43, 35 and 45, and 37 and 47 is preferably the same and preferably the same as the distance between the parallel walls. Present between outer perimeter 30 and inner perimeter 40 are media pleats. Thus, preferably, the depth of these media pleats is constant around filter element 10.

The polygonal shape, with radiused corners, provides improved properties for filter element 10 compared to round or oval shaped filter elements. It is generally known that a specific minimum amount of media is needed to achieve acceptable coalescing performance and filter life. With too little media area, filter face (or media face) velocities increase to an unacceptable level, which affects filter performance and shortens filter life. Having more than the minimum media area leads to improved coalescing and longer filter life, however, too much media area leads to pleat bunching on the inner perimeter. When pleat bunching occurs, filter resistance is increased and thus air flow is reduced, affecting the overall filter assembly operating performance. Having a polygonal shape with radiused corners allows the incorporation of the desired total media area while mitigating pleat bunching.

Employing a pleated media configuration allows more filtering media surface to be exposed to the incoming contaminated flow stream than if the media face was merely exposed. Pleat bunching occurs when too many pleats are provided in an area of an element, in order to obtain the desired total media area. The media thickness, physical characteristics of the media (e.g., stiffness), and manufacturing techniques affect the pleat-to-pleat packing density. In conventional round and oval shaped filter elements, pleat bunching occurs at the inner perimeter, because the inner perimeter is less than the outer perimeter. Deeper pleats, employed as a means to add media surface area, exacerbate the pleat bunching effect. As the pleat depth increases, the discrepancy between the pleat spacing at the inner perimeter compared to the outer perimeter increases. Pleat depth is typically about 1 to about 5 inches (about 2.5 to about 12.7 cm), preferably about 2 to about 4 inches (about 5 to about 10 cm).

Filter element 10, having straight side walls 32, 34, 36, 38, 42, 44, 46, 48, and other polygonal filter elements, mitigates pleat bunching in these areas. By having side walls 32, 34, 36, 38 on outer perimeter 30 the same length as side walls 42, 44, 46, 48 on inner perimeter 40, the pleat spacing is constant; that is, the pleat tip spacing at perimeter 30 is the same as at perimeter 40. Differences in pleat spacing occur at corners 31, 33, 35, 37, compared to corners 41, 43, 45, 47. Corners 41, 43, 45, 47 are a potential spot for pleat bunching, but bunching can be minimized in these corners by increasing the pleat spacing in these corner zones or increasing the radius of curvature.

Filter element 10 can be configured so that: (1) the pleat tip spacing around perimeter 30 is constant while the pleat tip spacing at corners 41, 43, 45, 47 is less than the spacing at corners 31, 33, 35, 37; (2) the pleat tip spacing around perimeter 40 is constant while the pleat tip spacing at corners 31, 33, 35, 37 is greater that at corners 41, 43, 45, 47; or (3) the pleat tip spacing around perimeter 30 varies (i.e., is different at corners 31, 33, 35, 37 than side walls 32, 34, 36, 38) and around perimeter 40 varies (i.e., is different at corners 41, 43, 45, 47 than side walls 42, 44, 46, 48). Preferably, however, the pleat tip spacing round perimeter 40 is constant thereby mitigating pleat bunching on perimeter 40.

A pleat density of about 3 to 12 pleats per inch (about 1.2 to 4.7 pleats per cm) is suitable for filter element 10, although higher and lower densities are also useable. Preferred spacing for mist collection, mist filtration or coalescing is about 4 to about 5.2 pleats per inch (about 1.6 to about 2 pleats per cm), and most preferred is 4.8 to 5.2 when employing a media with a thickness of 0.088 inch (2.2 mm). Preferred spacing for particulate (e.g., dust) collection or filtration is about 9 to about 12 pleats per inch (about 3.5 to 4.7 pleats per cm). A pleat spacing mechanism, such as beads of hot melt adhesive, metal or plastic or other pleat separators, embossed or corrugated filter media, or other spacing element is included to maintain the pleat density.

The pleat spacing is at least partially dependent on the thickness and the type of filter media. Common filter medias for mist collection or mist filtration include cellulose (e.g., paper), natural fibers, polymeric or synthetic fibers, and any combination thereof. Layers of microfibers or nanofibers could be used, see for example, U.S. Pat. Nos. 4,650,506; 6,743,273; 6,924,028; and 6,955,775, all which are incorporated herein by reference. To improve mist coalescing properties, an oleophobic material may be present in the filter media.

Examples of specific media include “Dryflo EN701311”, which has a thickness of greater than 0.027 inch (about 0.69 mm) and bi-component media, which have thicknesses of 0.044 to 0.132 inch (1.12 to 3.35 mm).

Again, filter element 10 is a polygonal filter with radiused corners. That is, media 25 of filter element 10, when viewed without end caps 22, 24, has a polygonal shape with radiused corners. This shape extends the length of media 25, from end cap 22 to end cap 24. Thus, any cross-section, taken parallel to end 12 or end 14, or orthogonal to the length, will be polygonal with radiused corners. Several views of media 25 of filter element 10 are illustrated in FIGS. 2, 3 and 4. Additionally, preferably when viewed from either end 12 or 14, end cap 22 or 24, respectively, has a polygonal shape with radiused corners.

Filter element 10A of FIG. 2 has side walls 32, 36 and 42, 46 longer than side walls 34, 38 and 44, 48. Filter element 10A has approximately a 2:1 aspect ratio of the walls. FIG. 3 shows a filter element 10, specifically filter element 10B, which has the four sidewalls generally equal. Filter element 10B has a 1:1 aspect ratio.

Various dimension measurements for filter element 10 are shown in FIG. 4. These dimension measurements are used in the Examples section, below.

DO₁ is a first outer length, measured between parallel outer perimeter side walls, and DO₂ is a second outer length, measured between parallel side walls orthogonal to DO₁. The ratio of DO₁ to DO₂ is the aspect ratio of the walls. DI₁ is a first inner length, measured between parallel inner perimeter side walls, and DI₂ is a second inner length, measured between parallel side walls orthogonal to DI₁. The ratio of DI₁ to DI₂ will generally be slightly different than the ratio of DO₁ to DO₂, thus, when the term “aspect ratio” for the side walls or for filter element 10 is used herein, what is intended is the ratio of DO₁ to DO₂. FIG. 4 also indicates LI₁ and LI₂, the length of inner perimeter side walls, and RI, the length of the radiused corners. The depth of media pleats, which is the distance between outer perimeter 30 and inner perimeter 40, is indicated as M.

On most embodiments, the aspect ratio of filter element 10, which is DO₁:DO₂, is 1:1 to about 2:1, although in some embodiments, higher aspect ratios may be suitable. It is understood, that for polygonal shapes other than rectangular, the aspect ratio will be computed differently.

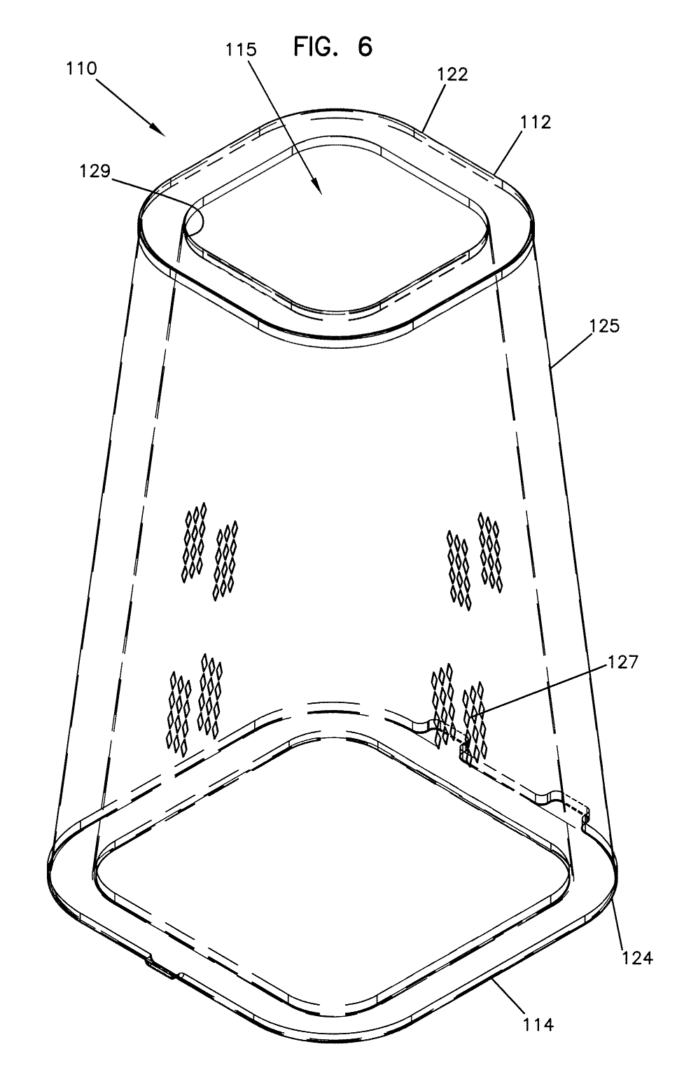

Filter element 10, discussed above, has a generally constant cross-sectional shape from first end 12 to second end 14. In alternate embodiments, the filter element may be tapered, so that the cross-sectional shape and/or size differs from the first end to the second end. Such a filter element is illustrated in FIG. 6 as filter element 110.

Similar to filter element 10, filter element 110 has a first end 112 and an opposite second end 114. An interior volume 115 is present between ends 112, 114. A first, “closed” end cap 122 is located at first end 112 and a second, “open” end cap 124 is located at second end 114. Each of end caps 122, 124 are polygonal end caps with radiused corners, conforming to the overall shape of element 110.

Filter element 110 includes an extension of pleated media 125 extending from and preferably potted into first end cap 122 to second end cap 124. Media 125, together with end caps 122, 124, define interior volume 115. An optional outer liner 127 surrounds media 125. An optional inner liner 129 is positioned inside media 125.

Similar to filter element 10, filter element 110 is a polygonal element having radiused corners, but tapering from second end 114 to first end 112.

Because of the taper, opposite walls, such as in a four sided element, are not parallel as they extend from first end 112 to second end 114, but rather, the walls converge at an angle. All or only some of the walls may be at an angle. For example, for a rectangular element, one pair of opposite walls tapers whereas the other pair of opposite walls does not taper, or alternately, all four walls taper.

In some embodiments, the taper of each wall is at an angle of no greater than about 20 degrees, often no more than about 15 degrees. In some embodiments, the taper is about 2-10 degrees. At a specific cross-sectional location, however, such as for a rectangular element, opposite walls will be parallel to each other. In some embodiments, the taper of each of the walls may be different.

The various features of filter element 110 can be the same as described for filter element 10, to the extent that the features are consistent.

### EXAMPLES

The following examples are given to show filter elements that have been made in accordance with the present disclosure. However, it will be understood that the following examples are exemplary only, and are in nowise comprehensive of the many different shapes, sizes, and types of filter elements which may be made in accordance with the present disclosure.

Various filter elements 10 were made having various dimensions, which are provided below in Tables 1 and 2 (in inches unless otherwise specified). Examples 1 through 6 were rectangular filter elements with radiused corners, whereas Example A was a conventional cylindrical filter element, as illustrated in FIG. 5.

TABLE 1

| | | | aspect | | | | | | |
|---|---|---|---|---|---|---|---|---|---|
| Ex. | DO₁ | DO₂ | ratio | DI₁ | DI₂ | LI₁ | LI₂ | RI | M |
| 1 | 12.00 | 11.25 | 1.066 | 5.40 | 5.75 | 4.0 | 1.85 | 3.14 | 2.60 |
| 2 | 15.25 | 9.50 | 1.605 | 9.53 | 3.78 | 5.85 | 1.50 | 3.14 | 2.86 |
| 3 | 16.5 | 16.5 | 1.0 | 10.90 | 10.90 | 7.10 | 8.50 | 3.14 | 2.60 |
| 4 | 19.75 | 14.25 | 1.386 | 14.03 | 8.53 | 10.35 | 6.25 | 3.14 | 2.86 |
| 5 | 19.75 | 14.25 | 1.386 | 14.03 | 8.53 | 10.35 | 6.25 | 3.14 | 2.86 |
| 6 | 23.75 | 18.25 | 1.301 | 18.03 | 12.53 | 15.75 | 10.25 | 3.14 | 2.86 |
| A | R₁ = | — | — | R₂ = | — | — | — | — | 2.60 |
| | 6.40 | | | 12.00 | | | | | |

TABLE 2

| | | | total | Pleats per | | | |
|---|---|---|---|---|---|---|---|
| | Filter height | | number of | inch (inner | media area | | Rated air flow |
| Ex. | (inches) | | pleats | annulus) | (sq. ft) | | (cfm) |
| 1 | 8 | (20.32 cm) | 110 | 4.8 | 30.1 | (2.79 m²) | 325 |
| 2 | 10 | (25.4 cm) | 123 | 4.8 | 42.8 | (3.97 m²) | 400 |
| 3 | 12 | (30.5 cm) | 185 | 4.8 | 77.0 | (7.15 m²) | 800 |
| 4 | 15 | (38.1 cm) | 206 | 4.8 | 107.4 | (9.98 m²) | 850 |
| 5 | 20 | (50.8 cm) | 206 | 4.8 | 143.2 | (13.3 m²) | 1200 |
| 6 | 25 | (63.5 cm) | 283 | 4.8 | 245.7 | (22.8 m²) | 2000 |
| A | 8 | (20.32 cm) | 110 | 5.2 | 30.1 | (2.79 m²) | 325 |

For each of the Examples, the filter media was 0.088 inch (2.24 mm) thick, and corrugated aluminum pleat spacers, having a corrugation height 0.056 inch (1.4 mm), were used to maintain the pleat spacing.

The radius of each of the corners for Examples 1 through 5 was 4 inches (10.16 cm). The pleats were arranged so that the pleat tip spacing was constant around the entire inner perimeter of the filter element.

The rated air flow levels for the filter elements of Examples 1-5 and Example A are also provided in Table 2.

The filter elements of Examples 1 and A were tested in a filter assembly. Their ability to filter out and coalesce mineral oil mist from an air stream was tested.

The dirty air plenum (i.e., the dirty side of the filter assembly) was 14 inches (35.6 cm) wide by 16 inches (40.6 cm) deep and 12.5 inches (31.75 cm) tall, providing an overall volume of 2800 inch³ (45,890 cm³).

Various amounts of mineral oil droplets, having a mean diameter of 1.3 micrometers, were entrained in the incoming air stream into the dirty air plenum.

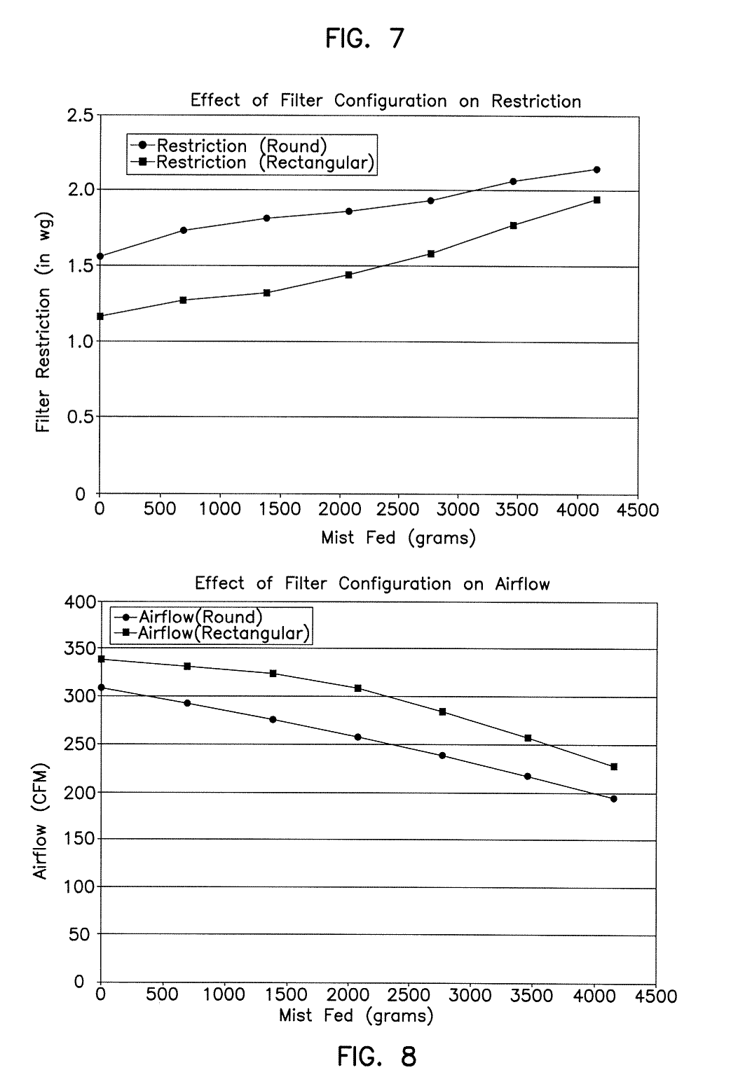

The filter restriction and the air flow through the filter element, as compared to the amount of mineral oil in the incoming air, were measured and the results are shown in FIGS. 7 and 8. The graph of FIG. 7 shows that the polygonal filter element had less filter restriction than the cylindrical filter element with equivalent pleat height and media area (25.6% less with no oil; 26.6% at 692 grams; 27.1% at 1385 grams; 22.6% at 2077 grams; 18.1% at 2769 grams; 14.1% at 3461 grams; and 9.3% at 4154 grams). The graph of FIG. 8 shows that the polygonal filter element had greater air flow than through than the cylindrical filter element with equivalent pleat height and media area (9.4% more with no oil; 13.0% at 692 grams; 17.4% at 1385 grams; 19.8% at 2077 grams; 19.3% at 2769 grams; 18.4% at 3461 grams; and 17.4% at 4154 grams).

It is to be understood, however, that even though numerous characteristics and advantages of the filters of the present disclosure have been set forth in the foregoing description, together with details of the structure and function of the filters, the disclosure is illustrative only, and changes may be made in detail, especially in matters of shape, size and arrangement of parts within the principles of the disclosure to the full extent indicated by the broad general meaning of the terms in which the appended claims are expressed.

What is claimed:

1. A filter element comprising:
(a) an extension of filter media having first and second opposite ends;
(i) the filter media being pleated;
(ii) the filter media being tubular and defining an filter interior;
(iii) the filter media having a polygonal cross-sectional shape comprising at least three side walls and three radiused corners;
(b) a first end cap and a second end cap;
(i) the filter media extending between the first and second end caps;
(ii) the first end cap being an open end cap providing access to the filter interior.

2. The filter element of claim 1, wherein filter media has a polygonal cross-sectional shape comprising at least four side walls and four radiused corners.

3. The filter element of claim 2, comprising four side walls:
(a) a first side wall;
(b) a second side wall adjacent the first side wall;
(c) a third side wall opposite to and parallel to the first side wall and adjacent the second side wall; and
(d) a fourth side wall opposite the second side wall and adjacent the first and third side walls.

4. The filter element of claim 3, wherein the filter media has a parallelogram cross-sectional shape.

5. The filter element of claim 3, wherein the filter media has a rectangular cross-sectional shape.

6. The filter element of claim 3, wherein a ratio of the length of the first and third side walls to the length of the second and fourth side walls is 1:1 to 2:1.

7. The filter element of claim 1, having a first cross-sectional shape proximate the first end cap and a second cross-sectional shape proximate the second end cap, wherein the first cross-sectional shape is different than the second cross-sectional shape.

8. The filter element of claim 1, having a first cross-sectional size proximate the first end cap and a second cross-sectional size proximate the second end cap, wherein the first cross-sectional size is different than the second cross-sectional size.

9. The filter element of claim 1, wherein the tubular media tapes from the first end cap to the second end cap.

10. The filter element of claim 1, wherein the second end cap is a closed end cap blocking access to the filter interior.

11. The filter element of claim 1, further comprising an inner liner extending between the first and second end caps, with the filter media circumscribing the inner liner.

12. The filter element of claim 1, further comprising an outer liner extending between the first and second end caps, with the outer liner circumscribing the filter media.

13. The filter element of claim 1, wherein the filter media comprises cellulose.

14. The filter element of claim 1, wherein the filter media comprises polymeric fibers.

15. The filter element of claim 14, wherein the filter media comprises fine fibers.

16. A filter element comprising:
(a) an extension of filter media:
(i) defining a polygonal cross-sectional shape comprising at least three side walls and three radiused corners;
(ii) having a plurality of pleats, each pleat having an inner tip and an outer tip, wherein the inner tips have a spacing that is generally the same at the at least three side walls and three radiused corners; and
(b) a first end cap and a second end cap;
(i) the filter media extending between the first and second end caps;
(ii) the first end cap being an open end cap providing access to the filter interior.

17. The filter element of claim 16, wherein the filter media has a polygonal cross-sectional shape comprising at least four side walls and four radiused corners, and wherein the inner tips have a spacing that is generally the same at the at least four side walls and four radiused corners.

18. The filter element of claim 16, further comprising pleat separators present between the pleats.

19. The filter element of claim 18, wherein the pleat separators comprise corrugated aluminum.
